(19) United States
(12) Patent Application Publication
(10) Pub. No.: US 2007/0206143 A1
(43) Pub. Date: Sep. 6, 2007

(54) Liquid Crystal Devices

(75) Inventors: William Alden Crossland, Harlow (GB); Anthony Bernard Davey, Cambridge (GB)

Correspondence Address: SUGHRUE MION, PLLC, 2100 PENNSYLVANIA AVENUE, N.W., SUITE 800, WASHINGTON, DC, 20037, US

(73) Assignee: CAMBRIDGE UNIVERSITY TECHNICAL SERVICES LIMITED

(21) Appl. No.: 10/558,980

(22) PCT Filed: Jun. 2, 2004
(86) PCT No.: PCT/GB04/02320

§ 371 Date: Jan. 25, 2007

(30) Foreign Application Priority Data
Jun. 2, 2003 (GB) 0312585.3

(51) Int. Cl. G02F 1/1343

(52) U.S. Cl. 349/141

(57) ABSTRACT

A liquid crystal device including a layer of liquid crystal material, and provided on one side of the liquid crystal material layer an array of conductors for generating electric fields therebetween to change the molecular orientation of pixel portions of the layer of liquid crystal material, wherein each pixel portion of the liquid crystal material layer is associated with a respective group of conductors distributed over the respective pixel area for the application of voltages across distances smaller than the pixel dimensions, wherein the conductors and the spacing therebetween within each group are sufficiently small with respect to the thickness of the liquid crystal material layer that each group can be used to generate an electric field that induces through at least a portion of the thickness of the liquid crystal material layer a different molecular orientation pattern that is substantially uniform across the whole area of the respective pixel portion.

The present invention relates to liquid crystal devices, and in particular to liquid crystal devices comprising an array of independently controllable pixels.

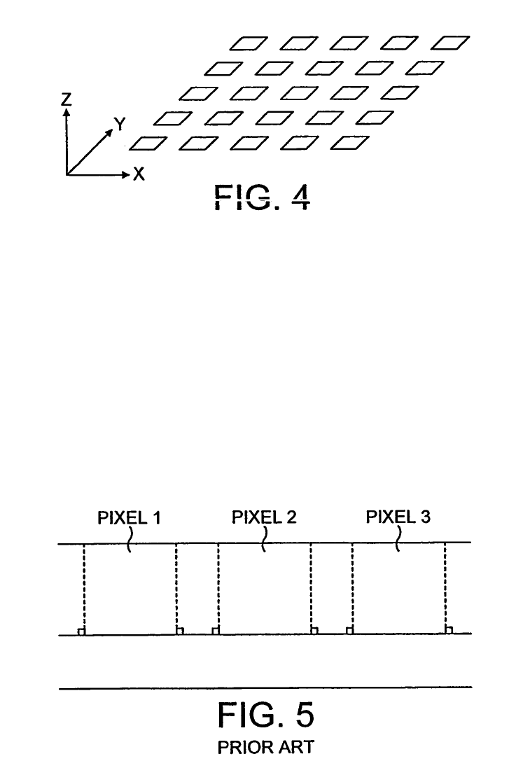

Existing pixellated liquid crystal devices generally involve switching the molecular orientation of pixel portions of a liquid crystal material layer using conductors to generate electric fields within the respective pixels portions of the liquid crystal material layer. These electric fields have been generated by applying a potential difference across the liquid crystal layer by means of electrodes provided on either side of the liquid crystal layer, or, as shown by the illustration of in-plane switching devices in FIG. 5, by applying a potential difference between a respective pair of longitudinal conductors on a common side of the liquid crystal layer at opposed edges of the respective pixel area.

The inventors of the present invention have found that useful in-plane switching liquid crystal devices may also be formed by switching the pixel portions using respective groups of conductors distributed across the respective pixel areas.

Accordingly, the present invention provides a liquid crystal device including a layer of liquid crystal material, and provided on one side of the liquid crystal material layer an array of conductors for generating electric fields therebetween to change the molecular orientation of pixel portions of the layer of liquid crystal material, wherein each pixel portion of the liquid crystal material layer is associated with a respective group of conductors distributed over the respective pixel area for the application of voltages across distances smaller than the pixel dimensions, the conductors and the spacing therebetween within each group are sufficiently small with respect to the thickness of the liquid crystal material layer that each group can be used to generate an electric field that induces through at least a portion of the thickness of the liquid crystal material layer a different molecular orientation pattern that is substantially uniform across the whole area of the respective pixel portion.

The present invention also provides a liquid crystal device including a layer of liquid crystal material, and provided on one side of the liquid crystal material layer an array of conductors for generating electric fields therebetween to change the molecular orientation of pixel portions of the layer of liquid crystal material, wherein each pixel portion of the liquid crystal material layer is associated with a respective group of conductors distributed over the respective pixel area for the application of voltages across distances smaller than the pixel dimensions, the thickness of the liquid crystal material layer being at least five times greater than the pitch of the conductors within each group.

In one embodiment, the liquid crystal is of a type that responds to the RMS (root mean square) of the voltage applied across the conductors, i.e. is insensitive to the polarity of the voltage applied across the conductors. One example of such a liquid crystal is the nematic phase, in which the liquid crystal switches orientation according to induced dipoles.

In one embodiment, the other side of the liquid crystal layer is provided with a transparent, conducting counter electrode which will be maintained at a constant voltage.

In one embodiment, the conductors have a pitch less than the wavelength of the light with which the device is used.

Each group of conductors may, for example, comprise an array of parallel longitudinal conductors, such as those provided by the digits of a pair of interdigitated electrodes, or, for example, a two-dimensional array of separate conductors.

The present invention also provides a display system and an optical switching system including a liquid crystal device according to the present invention.

According to another aspect of the invention, there is provided a liquid crystal display device including on one side of a layer of liquid crystal material at least one pair of interdigitated electrodes, wherein the width of the digits and the spacing between the digits is sufficiently small with respect to the thickness of the liquid crystal material layer that an electric field can be generated that induces through at least a portion of the thickness of the liquid crystal material layer a different molecular orientation pattern that is substantially uniform over both the digits and the spaces between the digits.

According to another aspect of the present invention, there is provided a liquid crystal display device including on one side of the liquid crystal layer at least one pair of conductors spaced in an X-direction, wherein the spacing between the conductors is sufficiently small with respect to the thickness of the liquid crystal material layer that an electric field can be generated that induces through at least a portion of the thickness of the liquid crystal material layer a different molecular orientation pattern that is substantially uniform over the area directly between the electrodes and an extension of that area in the Y-direction.

An embodiment of the present invention is described in detail hereunder, by way of example only, with reference to the accompanying drawings, in which:—

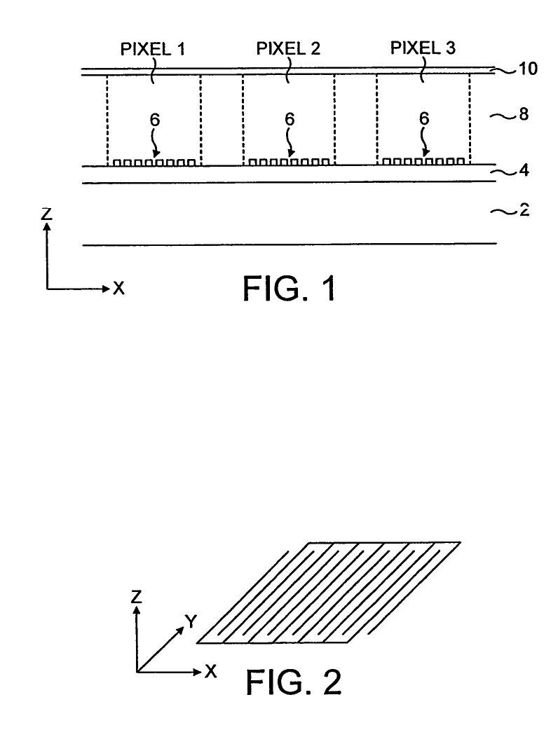

FIG. 1 illustrates the construction of a device according to an embodiment of the present invention;

FIG. 2 illustrates in more detail the configuration of the conductors used in the device of FIG. 1;

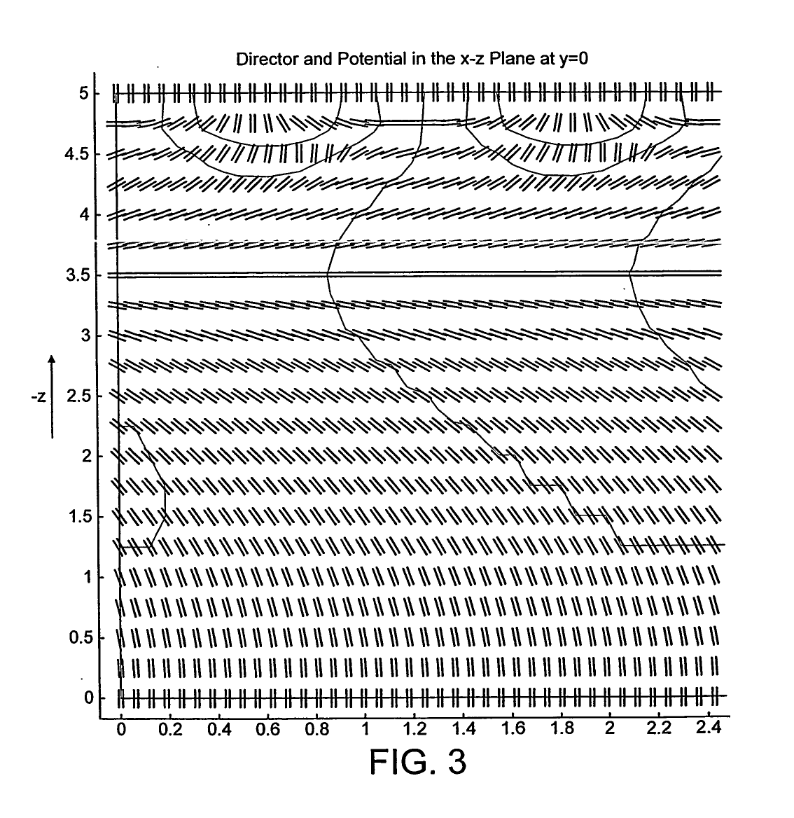

FIG. 3 illustrates the change in molecular orientation that may be produced using the conductor structures shown in FIGS. 1 and 2.

FIG. 4 illustrates an alternative conductor configuration for the device of FIG. 1;

FIG. 5 illustrates in cross-section a conventional in-plane switching liquid crystal device;

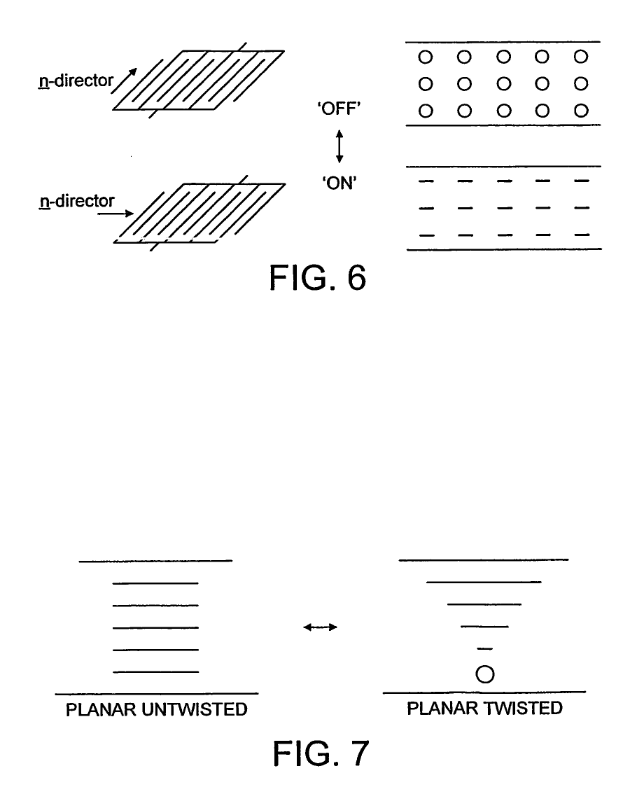

FIG. 6 illustrates switching between two planar untwisted alignments; and

FIG. 7 illustrates switching between a planar untwisted alignment and a planar twisted alignment.

The first embodiment of the present invention is an LCOS (Liquid Crystal over Silicon) device having a liquid crystal layer over a silicon VLSI chip. These kinds of devices normally operate in reflection and the liquid crystal layer modifies either the polarisation state or the phase of an incoming light beam. Electric fields generated in the liquid crystal layer result in changes in its optical properties, so that, in the case of display devices, images can be written to large arrays of pixels. The thickness of the liquid crystal layer is generally fixed by the optical function of the pixels and is related to the wavelength of the light used. For example, it may be chosen to give a retardation of ¼, ½ or a full wavelength retardation. For LCOS displays (visible light) or LCOS devices for telecommunications applications (near infra-red) operating in reflection (as is usual with LCOS devices), the thickness of the liquid crystal layer would generally be in the range of about 1 to 5 microns.

FIG. 1 illustrates a LCOS device according to a first embodiment of the present invention. including a silicon chip 2 with CMOS circuitry formed in an upper portion 4 thereof, groups of surface conductors 6 operatively coupled to underlying CMOS circuitry for generating electric fields in respective portions of the overlying layer of liquid crystal material 8. A transparent and conducting blanket layer 10 is provided on the other side of the layer of liquid crystal material as a “counter electrode” for all the conductor groups. In operation of the device, this “counter-electrode” is maintained at a constant voltage. For example, it may be grounded. FIG. 2 illustrates in plan view the configuration of each group of surface conductors in FIG. 1. As shown in FIG. 2, each group of conductors comprises the digits of a respective pair of interdigitated electrodes. The liquid crystal thickness will be related to the wavelength of the light being used as is indicated above. For this reason the micro-electrode structures being used here are considerably smaller than conventional pixels and may have a pitch that is smaller than the wavelength of the light being used.

As will be appreciated by the reader, a liquid crystal device will normally comprise a two-dimensional array of many more than the three pixels shown in FIG. 1 for illustration purposes.

FIG. 3 illustrates the kind of orientation to which a nematic liquid crystal may be switched from a homeotropic molecular orientation using the conductor configuration illustrated in FIG. 1 and FIG. 2. For FIG. 3, the conductors have a width of 0.25 microns and a spacing of 0.5 microns, and the liquid crystal material layer thickness is 5 microns. Deep-sub-micron silicon CMOS circuit fabrication can be used to photolithographically define features having sizes as small as the order of about 0.1 microns.

In FIG. 3, the vertical axis is the liquid crystal thickness in units of microns. +3.2 volts and −3.2 volts are respectively applied to alternate conductors 6 (not shown in FIG. 3) at z=−5 microns, and 0V is applied to the ‘counter-electrode’ (again not shown in FIG. 3) on the other surface of the liquid crystal material layer at z=0 microns, adjacent to which the liquid crystal is shown as remaining in the ‘homeotropic’ surface alignment).

In FIG. 3, the molecular orientation pattern through a major portion of the thickness of the liquid crystal material layer (about 3.5 microns thickness of the total 5 microns) is uniform in the x-direction over both the conductors and the spaces therebetween. For this major portion of the thickness of the liquid crystal layer it is considered that the anisotropy induced by the electric field applied along the surface by the interdigitated electrode structure is integrated over distances that are at least several times the pitch length of the conductor structure. This arises because there is a correlation distance associated with orientational order that characterises the liquid crystal phase. A consequence of this is that the elastic strain energy stored in the liquid crystal is minimised if throughout most of the thickness of the liquid layer it adopts a uniformly aligned structure.

FIG. 3 is a result of a computer simulation in which the elastic strain energy stored in the liquid crystal is minimised. It establishes that on the assumptions of the continuum theory of nematic liquid crystals, the minimum free energy does indeed occur when this uniform structure is attained.

When the electric field is removed the molecular orientation of the liquid crystal material reverts back to the homeotropic alignment. This type of switching of the orientation of a liquid crystal director is of use, for example, in multi-level amplitude and phase switching in display devices and optical components.

The initial homeotropic alignment that exists before any electric field is applied can be achieved, for example, by the use of a suitable surfactant material, by the use of a suitable polymeric material e.g. a polyimide material, or by evaporated films e.g. of SiO₂ at the surfaces bounding the liquid crystal material layer.

Each group of conductors includes more than two parallel longitudinal conductors extending right across the y-dimension of the respective pixel area for applying voltages across distances less than half of the pixel x-dimension. The relatively small spacing of the conductors within each group means that relatively large electric fields can be generated for a given voltage, or conversely that relatively small voltages are required to produce an electric field of a given strength.

The same kind of conductor structures may also be used to switch between other kinds of orientation alignments. One example is switching between orthogonal planar alignments, as shown in FIG. 6. In more detail, a nematic liquid crystal having a positive dielectric anisotropy may be made to switch from a first planar untwisted alignment with its azimuth parallel to the digits of the interdigitated electrodes to a second planar alignment in which the azimuth of the n-director is switched though 90 degrees. Other examples are switching between twisted and untwisted planar states, as shown in FIG. 7 and switching between two twisted states having a 90 degree difference in twist.

Each group of conductors may be configured and arranged differently to that shown in FIG. 2. For example, each group of conductors could, as shown in FIG. 4, comprise a two-dimensional array of commonly sized conductors distributed regularly across the pixel area. Appropriate voltages could be applied to each of the conductors by, for example, capacitive coupling to underlying circuitry. With this arrangement of conductors, different electric field patterns could be generated by varying the pattern in which voltages are applied to the conductors.

The applicant draws attention to the fact that the present invention may include any feature or combination of features disclosed herein either implicitly or explicitly or any generalisation thereof, without limitation to the scope of any definitions set out above. In view of the foregoing description it will be evident to a person skilled in the art that various modifications may be made within the scope of the invention.

1. A liquid crystal device including a layer of liquid crystal material, and provided on one side of the liquid crystal material layer an array of conductors for generating electric fields therebetween to change the molecular orientation of pixel portions of the layer of liquid crystal material, wherein each pixel portion of the liquid crystal material layer is associated with a respective group of conductors distributed over the respective pixel area for the application of voltages across distances smaller than the pixel dimensions, wherein the conductors and the spacing therebetween within each group are sufficiently small with respect to the thickness of the liquid crystal material layer that each group can be used to generate an electric field that induces through at least a portion of the thickness of the liquid crystal material layer a different molecular orientation pattern that is substantially uniform across the whole area of the respective pixel portion.

2. A liquid crystal device including a layer of liquid crystal material, and provided on one side of the liquid crystal material layer an array of conductors for generating electric fields therebetween to change the molecular orientation of pixel portions of the layer of liquid crystal material, wherein each pixel portion of the liquid crystal material layer is associated with a respective group of conductors distributed over the respective pixel area for the application of voltages across distances smaller than the pixel dimensions, wherein the thickness of the liquid crystal material layer is at least five times greater than the pitch of the conductors within each group.

3. A liquid crystal device according to claim 1, wherein each group of conductors comprises an array of parallel longitudinal conductors.

4. A liquid crystal device according to claim 3, wherein the conductors comprise the digits of a pair of interdigitated electrodes

5. A liquid crystal device according to claim 1, wherein each group of conductors is a two-dimensional array of separate conductors.

6. A display system including a liquid crystal device according to claim 1.

7. An optical switching system including a liquid crystal device according to claim 1.

8. A method of controlling the optical properties of a pixel portion of the liquid crystal material layer of the device according to claim 1, the method including applying voltages across conductors within the associated group so as to generate in said pixel portion of the liquid crystal material layer an electric field that induces through at least a portion of the thickness of the liquid crystal material layer a different molecular orientation pattern that is substantially uniform across the whole area of the pixel portion.

9. A liquid crystal display device including on one side of a layer of liquid crystal material at least one pair of interdigitated electrodes, wherein the width of the digits and the spacing between the digits is sufficiently small with respect to the thickness of the liquid crystal material layer that an electric field can be generated that induces through at least a portion of the thickness of the liquid crystal material layer a different molecular orientation pattern that is substantially uniform over both the digits and the spaces between the digits.

10. A method of operating a liquid crystal display device according to claim 9, including the step of applying a potential difference across the electrodes so as to generate in the liquid crystal material layer an electric field that induces through at least a portion of the thickness of the liquid crystal material layer a different molecular orientation pattern that is substantially uniform over both the digits and the spaces between the digits.

11. A liquid crystal display device including on one side of the liquid crystal layer at least one pair of conductors spaced in an X-direction, wherein the spacing between the conductors is sufficiently small with respect to the thickness of the liquid crystal material layer that an electric field can be generated that induces through at least a portion of the thickness of the liquid crystal material layer a different molecular orientation pattern that is substantially uniform over the area directly between the electrodes and an extension of that area in the Y-direction.

12. A method of operating a liquid crystal display device according to claim 11, including the step of applying a potential difference across the conductors so as to generate in the liquid crystal material layer an electric field that induces through at least a portion of the thickness of the liquid crystal material layer a different molecular orientation pattern that is substantially uniform over the area directly between the electrodes and an extension of that area in the Y-direction.
